(19) United States
(12) Patent Application Publication
(10) Pub. No.: US 2001/0024627 A1
(43) Pub. Date: Sep. 27, 2001

(54) Catalyst carrier

(76) Inventor: Sven Melker Nilsson, Kallered (SE)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/811,418

(22) Filed: Mar. 20, 2001

(30) Foreign Application Priority Data
Mar. 21, 2000 (SE) 0000972-0

(51) Int. Cl. B01D 53/34; B01D 53/94; B01D 53/88; F01N 3/28

(52) U.S. Cl. 422/180; 502/527.23; 422/177

(57) ABSTRACT

A catalyst carrier for exhaust systems in internal combustion engines, the catalyst carrier being made of wound metal foils and equipped with a mantle consisting of at least two portions (12, 13) having bent-out edges (16, 17), the portions being clamped around the catalyst carrier with the bent-out edges in mutual contact and joined to form longitudinal flanges (18) for instance by means of welding, upon which the flanges are usable to prevent rotation or displacement of the catalyst carrier when this is mounted in a canning included in an exhaust system.

### BACKGROUND

Catalysts are frequently used in exhaust systems of internal combustion engines in order to avoid emissions of gases that are hazardous to the environment. Catalyst materials are applied in thin layers on a catalyst carrier provided with a plurality of parallel slits. A current catalyst carrier embodiment consists of a roll of alternating flat and corrugated metal foils. During operation, the catalyst carrier is strongly heated to a temperature range of 200 to 1,000 degrees, partly due to the temperature of the supplied exhaust gas and partly by the additional power development caused by the combustion of carbon monoxide and any other harmful gases contained in the exhaust gas. It is necessary to keep the catalyst carrier apart from the outer housing, called canning, incorporated in the exhaust system, for two reasons: one is to prevent the exhaust system from being heated to a temperature that may cause fire, the other is to prevent parts of the catalyst layer from being cooled to a temperature at which they become inactive. In order to maintain the shape and the cohesion of the catalyst carrier, it is also necessary that the expansion of the catalyst carrier caused by heating is not prevented or does not exert excessive stresses.

There are several previously known methods of producing and installing catalyst carriers for this purpose. EP patent specification 705,962 discloses a catalyst carrier which is fixed in a tubular mantle with thick walls and varied diameter, the diameter being smaller in the mantle portion touching the catalyst carrier and larger in the mantle portion fastened over a flange to the outer housing. A similar solution, in which the outer housing has conical parts and tapers locally so at to get into direct contact with the tubular mantle, is disclosed by WO/96/34188. EP patent specifications 705,963 and 724,070, and also DE 196,36662 show that the catalyst carrier can be kept apart from the outer housing by means of a layer of heat-insulating material, such as mineral fibres. In accordance with DE 195,01360, the fibre layer may contain metal sheets with stamped-out flaps in order to prevent the fibres from being deformed or blowing away. In another embodiment, the catalyst carrier is performed with a rigid tubular mantle with thick walls, whose ends extend beyond the catalyst carrier, and is here equipped with flanges attached to the outer housing.

The known embodiments have the serious inconvenience of the wall thickness of the mantles having to be relatively large in order to allow solid securing to the outer housing, and this is a feature that makes the mounting of the mantle on the catalyst carrier more difficult and expensive and delays the heating, ignition and operation of the catalyst carrier during use. The present invention relates to catalyst carrier enveloping that allows simple fastening of the mantle to the outer housing, prevents unnecessary heat transfer between the mantle and the outer housing, and permits thermal expansion of the mantle and the catalyst carrier, and which in certain embodiments allows simple replacement of the catalyst carrier, should this have lost its activity by being exposed to excessively high temperature, by damage under vibration, by chemical action or any other damage. Normally the mantle surrounding the actual catalyst body consists of a mantle with a thickness of 1-1.5 mm. This mantle will form a substantial part of the thermal mass of the catalyst, and thus delay the ignition and activity of the catalyst. According to the present invention, a very thin mantle can also be simply and reliably secured to the canning in the exhaust system. This enables a mantle thickness of only 0.1 mm to be fastened. The thermal mass is thus considerably reduced and the catalyst is more rapidly ignited and activated.

### DESCRIPTION

A catalyst carrier mantle in accordance with the invention is described with reference to the figures, in which

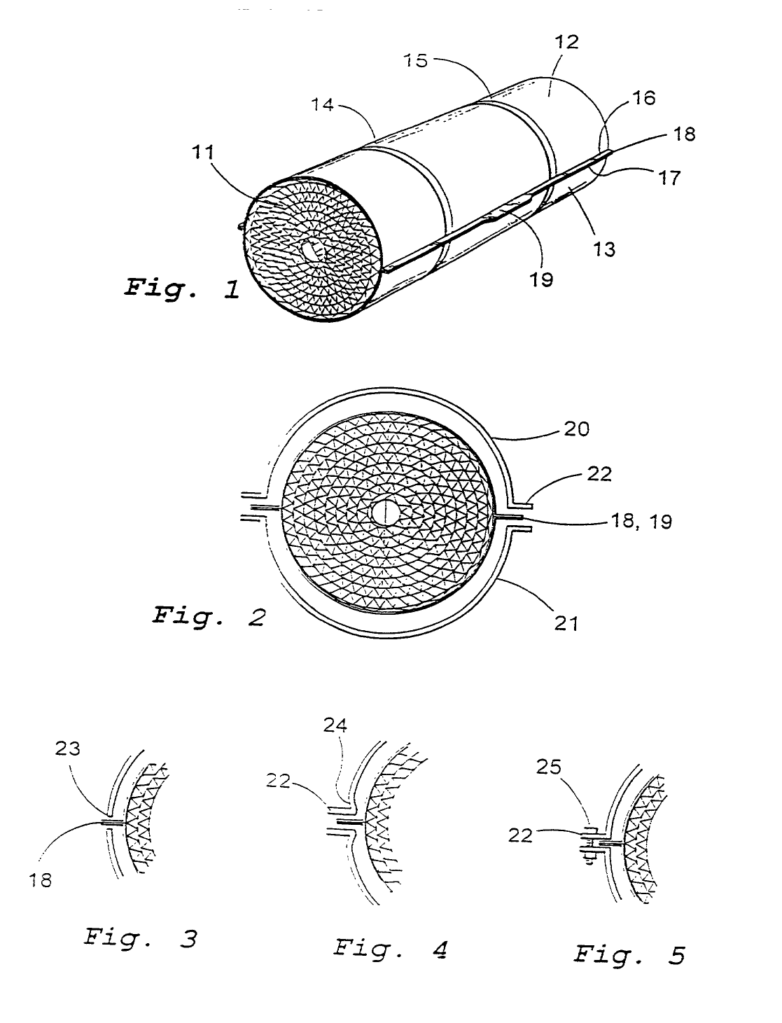

FIG. 1 shows a catalyst carrier with a mantle,

FIG. 2 shows the same in cross-section when mounted in a canning included in an exhaust system.

FIGS. 3, 4 and 5 show detail views of various options of assembling the canning parts.

In catalyst carriers that have been manufactured by winding flat and corrugated metal foils, the foil layers are normally retained by soldering, by pins inserted through the foils or by tangential folds in the folds. Tangential folds may also have the purpose of causing turbulence in the exhaust flow of the slits, as in WO97/21489.

In accordance with the invention, the catalyst carrier 11 is equipped over its entire length with a mantle consisting of at least two parts 12, 13 and is retained in the mantle owing to tangential inwards folds 14, 15 in the mantle, which engage matching folds in the catalyst carrier, at least in the outer layer of this. The mantle is mounted on the catalyst carrier 11 by pressing together the mantle parts 12, 13 with its bent-out edges 16, 17 in mutual contact and by joining them by point welding or continuous welding, forming longitudinal flanges 18, which may be provided with protruding tongues 19. In the main option, the flanges of the canning made up of the two tube portions 12, 13 are joined by welding, and then the flanges of the thin mantle caught between those of the canning will be fastened by welding at the same time. In order to reduce differences of material expansion caused by temperature variations in the flanges of the canning and those of the catalyst body, laser welding can be directed so as to join the catalyst flanges only over short sections. Optionally, the flanges of the thin mantle are shaped with protruding flaps in the centre, for instance. With these methods, the flanges will be joined by welding only over a short section, where the temperature differences do not cause any major differences of material expansion caused by temperature variation. In the remaining portions, the flanges are only caught between the flanges, and then motions caused by temperature differences will not result in any notable stresses on the welded joint.

For mounting in a canning included in the exhaust system, the canning must consists of at least two portions 20, 21 which can be joined by welding or can be detachably assembled by means of bolts 25 or the like.

The canning portions are made so as to have an inner diameter that is greater than the outer diameter of the mantle over the main portion of the length of the catalyst carrier, but has principally the same diameter in at least one section of the length. This arrangement prevents exhaust gases from flowing through the space between the mantle and the canning. The input flow of hot gases between the catalyst capsule and the inner side of the exhaust system is insignificant if the area of contact between the mantle and the canning is located at the input end, since the contact becomes tighter when the catalyst carrier is hot. However, if desired, a minor amount of sealing material can be applied at this location. The contact within this area will vary considerably along with the temperature of the catalyst carrier, and will be at a maximum when the catalyst carrier is hot. Should no special actions be taken, the cool mantle would be in danger of coming off and of being displaced or of rotating relative to the canning. For this reason, the longitudinal flanges 18 or their tongues 19 are allowed to protrude between the portions 20, 21 of the outer capsule in accordance with the invention.

To allow solid welding of the portions 20, 21 of the outer capsule to the flanges 18 or tongues 19 of the mantle, the portions are preferably provided with bent-out edges 22, and then the welding can be simply performed without strict precision requirements. If the outer capsule is only welded to the tongues, heat stresses in the longitudinal direction will be reduced. Optionally, the outer capsule can be joined by welding such that the mantle flanges 18 are joined by welding to the outer capsule only over a shorter distance in order to reduce heat stresses in the longitudinal direction.

FIG. 3 shows a detail of a section in the area of the welded joint, in a case where protruding strips should be avoided in the finished canning, for instance for motorcycles. The canning can then be made from a tube with thicker walls, which is provided with two diametrically opposed narrow slots 23 from the tube end, and the flanges 18 of the catalyst carrier are inserted in the cut, which is subsequently closed by welding, and after this the welded joint can be dressed down if desired.

FIG. 4 shows how the correct position for the catalyst carrier can be ensured between the canning portions by providing the portions with inward bent portions 24 over at least part of its length, e.g. adjacent to the bent-out edge 22. In order to ensure the correct position of the catalyst carrier also in the longitudinal direction, before the edges of the canning are welded, the inward bent portions 24 may be restricted to the portions of the mantle where this is provided with tangential inward folds 14, 15, and they may be deep enough to engage these folds. The inward bent or stamped portions also have the function of reducing the bending moment in the flanges 18 of the catalyst carrier mantle, because the points of support for the flanges will be approached to the mantle of the catalyst body. This is particularly important when the mantle consists of a thin material, as described above.

FIG. 5 shows an embodiment where the canning portions are joined by bolts 25 inserted through holes in the bent-out edges 22, the bolts also preventing displacement of the catalyst carrier. This embodiment, or embodiments comprising similar fastening means, is preferably intended for use in cases where the catalyst ought to be rapidly replaced in the event of decreased activity, or where welding is inadequate for the materials used. In order to prevent exhaust gas emissions in such cases, a sealing material can be applied between the canning portions 20, 21 outside the longitudinal flanges 18, 19.

The embodiments may also differ from those described above within the scope of the inventive idea, for instance with regard to the inner or outer shape of the catalyst carrier, the number of tongues or fastening means.

1. Catalyst carrier monolith with canning, for use in exhaust systems, characterized by the canning comprising at least two portions (12, 13) with bent-out edges (16, 17) touching each other when the portions are pressed together to contact end enclose the monolith (11), said edges being united to longitudinal flanges (18).

2. Catalyst carrier according to claim 1, characterized by the flanges (18) being provided with farther extended tongues (19).

3. Catalyst according to claim 1 or 2, characterized by the edges being united by welding.

4. Catalyst carrier according to claim 1, characterized by the portions (12, 13) of the canning being made with inward tangential folds (14, 15) penetrating the outermost layers of the monolith.

5. Catalyst carrier according to claim 4, characterized by the monolith being provided with tangential folds in its outer layers corresponding to folds (14, 15) of the canning portions, before mounting of the canning.

6. Catalyst carrier according to claim 1 or 2, characterized by being attached to an outer capsule which is part of the exhaust system and comprises at least two portions (20, 21), where the flanges (18) or their tongues (19) extend between the capsule portions.

7. Catalyst carrier according to claim 6, characterized by the capsule portions being united with each other and with the canning by welding.

8. Catalyst carrier according to claim 6, characterized by the capsule being provided with inward indentations (24) which ensure a spacing between the capsule and the canning.

9. Catalyst carrier according to claim 1, characterized by the thickness of the canning being from 1 mm to 0.1 mm.
